(19) United States
(12) Patent Application Publication
(10) Pub. No.: US 2009/0073596 A1
(43) Pub. Date: Mar. 19, 2009

(54) HYDRODYNAMIC BEARING DEVICE, AND SPINDLE MOTOR AND INFORMATION PROCESSING APPARATUS EQUIPPED WITH THE SAME

(76) Inventors: Takafumi Asada, Osaka (JP); Tsutomu Hamada, Osaka (JP); Katsuo Ishikawa, Ehime (JP)

Correspondence Address: WENDEROTH, LIND & PONACK L.L.P., 2033 K. STREET, NW, SUITE 800, WASHINGTON, DC, 20006, US

(21) Appl. No.: 12/169,474

(22) Filed: Jul. 8, 2008

(30) Foreign Application Priority Data
Sep. 19, 2007 (JP) 2007-241890

(51) Int. Cl. G11B 5/02; F16C 17/10; H02K 15/14

(52) U.S. Cl. 360/55; 384/112; 310/42; G9B/5.026

(57) ABSTRACT

A hydrodynamic bearing device comprises a sleeve composed of a sintered member, a shaft that is inserted in a state of being capable of relative rotation into a bearing hole provided to the sleeve, and a hydrodynamic groove formed in the outer peripheral surface of the shaft and/or the inner peripheral surface of the sleeve. The sleeve has a surface porosity of 1.5% or less, and the ridge width is at least 0.10 mm.

### BACKGROUND OF THE INVENTION

1. Field of the Invention

The present invention relates to a hydrodynamic bearing device that is installed in an information processing apparatus, such as a hard disk drive device (hereinafter referred to as a HDD device), an optical disk device, an magneto-optical disk device, or a CPU cooling fan used in a personal computer, and to a spindle motor and an information processing apparatus equipped with this bearing.

2. Description of the Related Art

Information processing apparatuses and so forth that make use of a rotating disk have grown in memory capacity in recent years, and their data transfer rates have also been on the rise. The bearings used in these information processing apparatuses therefore need to offer high reliability and performance for rotating a disk load at a high degree of accuracy. Hydrodynamic bearing devices, which are well suited to high-accuracy rotation, have been used in these rotating devices.

With a hydrodynamic bearing device, a lubricant (oil) is interposed in a tiny gap between a shaft and a sleeve, pumping pressure is generated by hydrodynamic grooves during rotation, and this pressure rotates the shaft in non-contact fashion with respect to the sleeve. Thus, there is almost no mechanical friction between the shaft and the sleeve, which makes hydrodynamic bearing devices suited to high-speed rotation.

An example of a conventional hydrodynamic bearing device will now be described through reference to FIG. 16.

As shown in FIG. 16, a sleeve 30 has a bearing hole 30A, is made of a sintered metal, produced by sintering a copper alloy or other metal microparticles, and is integrally inserted and fixed in the interior of a cover 31 made from metal or plastic. Also, the sleeve 30 is a sintered metal containing at least 60 wt % copper alloy. The interior of the sleeve 30 has been impregnated at low pressure with oil 41. The volumetric density thereof is about 88%.

A shaft 32 is inserted in a rotatable state in the bearing hole 30A, and has an integral flange 36.

The flange 36 is accommodated in a space between a base 40 and a thrust plate 37, or in a space between the sleeve 30 and the thrust plate 37. One side of the flange 36 is provided in a rotatable state opposite the thrust plate 37.

A rotor hub 35 is fixed to the shaft 32. A rotor magnet 34 is fixed to the rotor hub 35.

A motor stator 39 that is opposite the rotor magnet 34 is attached to the base 40.

Hydrodynamic grooves 33A and 33B are formed on the inner peripheral surface of the bearing hole 30A of the sleeve 30 and/or the outer peripheral surface of the shaft 32.

A hydrodynamic groove 38A is formed in the opposing surface between the flange 36 and the thrust plate 37, and a hydrodynamic groove 38B is formed as necessary in any one of the opposing faces between the flange 36 and the sleeve 30.

The oil 41 is injected near the hydrodynamic grooves 33A, 33B, 38A, and 38B.

FIG. 16 will be used to describe the operation of a conventional hydrodynamic bearing device configured as above.

First, a rotary magnetic field is generated when power is sent to the motor stator 39, and the shaft 32, the flange 36, and the rotor magnet 34 begin to rotate along with the rotor hub 35. At this point the hydrodynamic grooves 33A, 33B, 38A, and 38B scrape off the oil 41 and generate pumping pressure. This lifts up the rotor part, which includes the shaft 32, the flange 36, the rotor magnet 34, and the rotor hub 35, which rotate in a state of non-contact.

As shown in FIG. 16, the shaft 32 is inserted in a rotatable state in the bearing hole 30A of the sleeve 30. The sleeve 30 has on its bearing sliding face pores 30D of about 2 to 20 surface area % (see the black portions in FIG. 17). The amount of pores (hereinafter referred to as surface porosity) is generally expressed as the proportion of the surface area accounted for by pores, per unit of surface area.

FIGS. 18 and 19 are cross sections of the area near the surface of the sleeve in FIG. 16. The volumetric density of a conventional sintered sleeve is about 88%, and there are many pores that communicate with other regions, as indicated by the letter U.

Patent Document 1: Japanese Laid-Open Patent Application 2005-256968

Patent Document 2: Japanese Laid-Open Patent Application 2006-046540

### DISCLOSURE OF THE INVENTION

### PROBLEM TO BE SOLVED BY THE INVENTION

With the conventional configuration above, however, the following problems were encountered.

Because there were many of the pores 30D in the surface of the sleeve 30, there was the risk that the about 20% or more of the pressure (approximately 2 to 5 atmospheres) generated inside the bearing by the pumping action of the hydrodynamic grooves 33A, 33B, 38A, and 38B would leak out from the pores 30D on the surface. Consequently, the stiffness of the radial bearing decreased by at least 20%, the shaft 32 could not be kept in a non-contact state during its rotation, and came into contact with and rubbed against the sleeve 30.

As shown in FIGS. 18 and 19, sintered metal particles are sintered to form a hydrodynamic face composed of a sintered member. A hydrodynamic groove is machined, for example, by rolling using hard balls as discussed in Japanese Patent No. 1,703,590.

Also, as shown in FIG. 19, the hydrodynamic face has a groove portion (Bg) and a ridge portion (Br: the flat portion where there is no groove). Here, if we assume a relative speed with respect to the opposing flat face on the surface of the shaft 2, since the gap changes in the portion of the hydrodynamic groove 33A, a fluid dynamic constriction effect generates higher pressure at the ridge portion (Br), which lifts the shaft 2 and allows it to rotate in a non-contact state.

If the volumetric density of the sleeve here is low, then as shown in FIG. 19, there will be through-holes U that communicate between the ridge and groove portions of the hydrodynamic face, and the high pressure generated at the ridge portion may leak into the groove portion.

Thus, with a conventional hydrodynamic bearing device, since pressure leaks and does not rise during rotation, there is the risk that the shaft 32 will not be lifted up, and will instead come into contact and be damaged. Not only does pressure leak from the through-holes U, but there is also the risk that the lubricant 41 will leak outside of the sleeve 30. The amount of the through-holes U is quantitatively expressed by the through-porosity (volumetric percent). As discussed above, the through-holes may communicate between the ridge portion and the groove portion of the hydrodynamic face, or may communicate from the ridge portion or groove portion of the hydrodynamic face to the outer peripheral part of the sleeve, or may be a combination of these.

Also, in FIG. 18, the letter V indicates substantially round or streak-like depressions remaining on the surface, which are called surface pores. These surface pores V may adversely affect the generation of pressure in the hydrodynamic groove 33A.

Also, the sleeve 30 is composed of a material impregnated at low pressure with the oil 41 in the interior of the sleeve 30 through the pores 30D in the surface. Here, the impregnating oil 41 flows out of the sleeve 30 due to elevated temperature, etc., inside the bearing. Gas from the oil that has oozed out onto the cover 31 and evaporated can be a problem in that it pollutes the surrounding air.

Further, as shown in FIG. 16, the oil 41 oozes out from the surface of the sleeve 30. Therefore, if the sleeve 30 is not completely covered by the cover 31, there is the risk that the oil in the gap 30A of the bearing will eventually dry up. Consequently, since oil oozes out from the surface, the sleeve cannot be attached directly to the base. Thus, the cost rises because the cover 31 has to be used, and since the sleeve 30 is attached to the base 40 via the cover 31, attachment precision (squareness) decreases between the sleeve 30 and the base 40, and there is the risk that the performance of the rotational device may suffer.

It is an object of the present invention to solve the above problems encountered in the past and to provide a hydrodynamic bearing device with which leakage of pressure generated in hydrodynamic grooves from pores on the sleeve surface is suppressed, and oil can be prevented from oozing out from the surface of the sleeve, which is composed of a sintered material.

### SUMMARY OF THE INVENTION

The hydrodynamic bearing device of the present invention comprises a sleeve composed of a sintered member, a shaft that is inserted in a state of being capable of relative rotation into a bearing hole provided to the sleeve, and a hydrodynamic groove formed in the inner peripheral surface of the sleeve. The sleeve has a surface porosity of 1.5% or less, and the ridge width is at least 0.10 mm.

Also, the hydrodynamic bearing device of the present invention comprises a sleeve composed of a sintered member, a shaft that is inserted in a state of being capable of relative rotation into a bearing hole provided to the sleeve, and a hydrodynamic groove formed in the inner peripheral surface of the sleeve. The sleeve has a volumetric density of at least 92%, and the ridge width of the hydrodynamic groove is at least 0.10 mm.

Also, the hydrodynamic bearing device of the present invention comprises a sleeve composed of a sintered member, a shaft that is inserted in a state of being capable of relative rotation into a bearing hole provided to the sleeve, and a hydrodynamic groove formed in the inner peripheral surface of the sleeve. The sleeve is such that the value of the following function F is 15.0 or less.

Function F=surface porosity (surface area %)/ridge width (mm)

Further, with the hydrodynamic bearing device of the present invention, it is preferable if iron accounts for at least 80% of the sleeve material, and if an iron oxide film whose main portion is triiron tetroxide or di-iron trioxide is formed in a thickness of at least 2 μm on the surface.

In other words, the pressure generated by the hydrodynamic groove is low enough that it will not leak out from the surface pores of the sintered material, and to that end, the volumetric density and surface porosity, which are parameters of the sintered metal, are set within specific ranges with which no pressure leakage will occur, and the ridge width is set to be at least a critical value.

The means for keeping the surface porosity to a specific value or lower is to keep the volumetric density of the sinter to at least a specific value, and to keep the ridge width to at least a critical value.

Also, an iron oxide film of at least a certain thickness is applied to the surface.

Further, problems encountered in the bearing gap at low temperatures and caused by a difference in the coefficients of thermal expansion between the sleeve and shaft are solved by having at least 80% of the material of the sintered sleeve be iron.

### BRIEF DESCRIPTION OF DRAWINGS

FIG. 1 is a cross section of a hydrodynamic bearing device in an embodiment of the present invention;

FIG. 2 is a detail cross section of the sleeve in the hydrodynamic bearing device;

FIG. 3 is a cross section of a sleeve composed of a sintered material and included in the hydrodynamic bearing device;

FIG. 4 is a diagram illustrating the principle of hydrodynamic generation in the hydrodynamic bearing device;

FIG. 5 is a diagram of an internal-pore and a surface pore in the hydrodynamic bearing device;

FIG. 6 is a graph of porosity and volumetric density in the hydrodynamic bearing device;

FIG. 7 is a graph of proportional radial stiffness and surface porosity with the hydrodynamic bearing device;

FIG. 8 is a diagram of surface pores with the hydrodynamic bearing device;

FIG. 9 is a diagram of surface pores with the hydrodynamic bearing device;

FIG. 10 consists of graphs of the results of measuring porosity with the hydrodynamic bearing device;

FIG. 11 is a graph of proportional radial stiffness and surface porosity as a function of ridge width with the hydrodynamic bearing device;

FIG. 12 is a graph of proportional radial stiffness and the function F with this hydrodynamic bearing device;

FIG. 13 is a graph of pressing load and the function F in the hydrodynamic bearing device;

FIG. 14 is a diagram of the surface iron oxide film with the hydrodynamic bearing device;

FIG. 15 is a cross section of an information recording and reproduction processing apparatus in which the hydrodynamic bearing device is used;

FIG. 16 is a cross section of a conventional hydrodynamic bearing device;

FIG. 17 is a diagram of pores on the surface of a conventional sintered material;

FIG. 18 is a diagram of a through-pore, a surface pore, and an internal pore in a conventional hydrodynamic bearing device; and

FIG. 19 is a cross section of a sleeve composed of a sintered material and included in a conventional hydrodynamic bearing device.

### DETAILED DESCRIPTION OF THE PREFERRED EMBODIMENTS

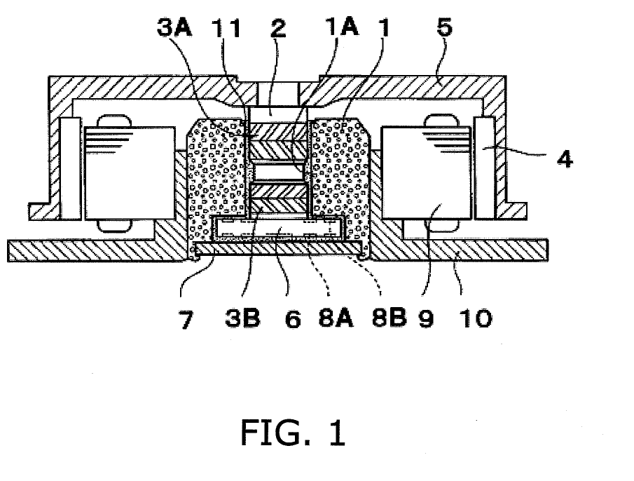

Embodiments of the hydrodynamic bearing device of the present invention, and an information recording and reproduction processing apparatus (an information processing apparatus) equipped with this bearing, will now be described through reference to FIGS. 1 to 14.

FIG. 1 is a cross section of a spindle motor including a hydrodynamic bearing device in an embodiment. First, we will describe the configuration of the hydrodynamic bearing device in this embodiment.

A sleeve 1 has a bearing hole 1A, and a shaft 2 is inserted in a rotatable state in this bearing hole 1A. The sleeve 1 is fixed to a base 10 along with a motor stator 9.

A radial bearing face having hydrodynamic grooves 3A and 3B, which consist of shallow patterned grooves, is provided to the inner peripheral surface of the sleeve 1 opposite the outer peripheral surface of the shaft 2. A rotor hub 5 having a rotor magnet 4 is attached on the upper side of the shaft 2. A thrust flange 6 that is at a right angle to the shaft 2 is attached integrally to the other end of the shaft 2 (the lower side in FIG. 1).

The bearing face at the lower end side of the thrust flange 6 is disposed opposite a thrust plate 7.

The thrust plate 7 is fixed to the sleeve 1.

A hydrodynamic groove 8A is formed in a spiral or herringbone pattern in the face of either the thrust flange 6 or the thrust plate 7.

Also, a hydrodynamic groove 8B is formed as necessary in either the face opposite the lower end face of the sleeve 1 or the upper flat part of the thrust flange 6.

The gap between the shaft 2 and the sleeve 1, and the gap between the thrust flange 6 and the thrust plate 7 are filled with a lubricant 11 such as oil.

In addition to oil, an ionic liquid or a superfluid grease can also be used as the lubricant 11.

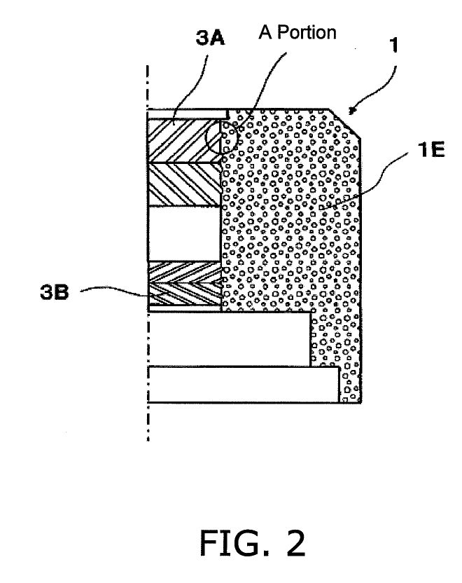

In FIGS. 1 and 2, the radial hydrodynamic grooves 3A and 3B are formed in the inner peripheral surface of the sleeve 1 opposite the outer peripheral surface of the shaft 2.

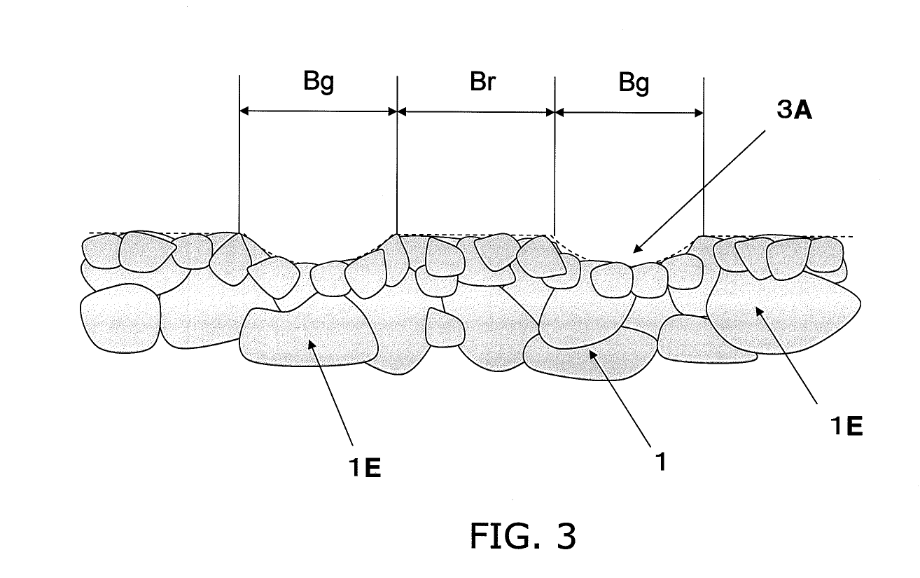

FIG. 2 is a detail view of the portion around the radial hydrodynamic grooves 3A and 3B formed in the inner peripheral surface of the sleeve 1. FIG. 3 is a diagram illustrating a sintered material, in which the A portion in FIG. 2 has been further enlarged.

The sleeve 1 is produced by sintering numerous metal microparticles 1E, but since the sleeve 1 is molded by firmly pressing with a press (not shown), there is almost no space between the metal microparticles 1E. In particular, the pressure exerted by the press is sufficiently high at the surface of the sleeve 1, and the pores remaining on the surface are molded such that the surface porosity is no more than 1.5%.

Also, as shown in FIG. 1, the sleeve 1 is attached directly to the base 10, and there is no need for the cover 31 (see FIG. 16) that was provided to the conventional hydrodynamic bearing device.

The operation of a hydrodynamic bearing device configured as above will be described in embodiments of the present invention through reference to FIGS. 1 to 14.

First, in FIG. 1, a rotary magnetic field is generated when power is sent to the motor stator 9, and the rotor magnet 4 begins to rotate along with the rotor hub 5, the shaft 2, and the thrust flange 6. When rotation commences, the oil or other lubricant 11 that has flowed into the hydrodynamic grooves 3A, 3B, 8A, and 8B generates pumping pressure, and the pressure in the bearing begins to rise. At this point the shaft 2 is lifted up and rotates at high precision and in a state of non-contact.

Although not depicted, one or more magnetic disks or optical disks may be fixed to the rotor hub 5. The rotor hub 5 rotates along with these disks, and a head (not shown) is used to record or reproduce electrical signals to or from the disks.

The detailed configuration of the hydrodynamic face and the hydrodynamic mechanism will now be described.

FIGS. 3 to 5 are detail cross sections illustrating the hydrodynamic face formed in the inner peripheral surface of the sleeve 1 in this embodiment. Bg in the drawings is the groove width, and Br is the ridge width (the shortest distance between grooves).

As shown in FIG. 3, a hydrodynamic face composed of a sintered member is formed by molding sintered metal particles.

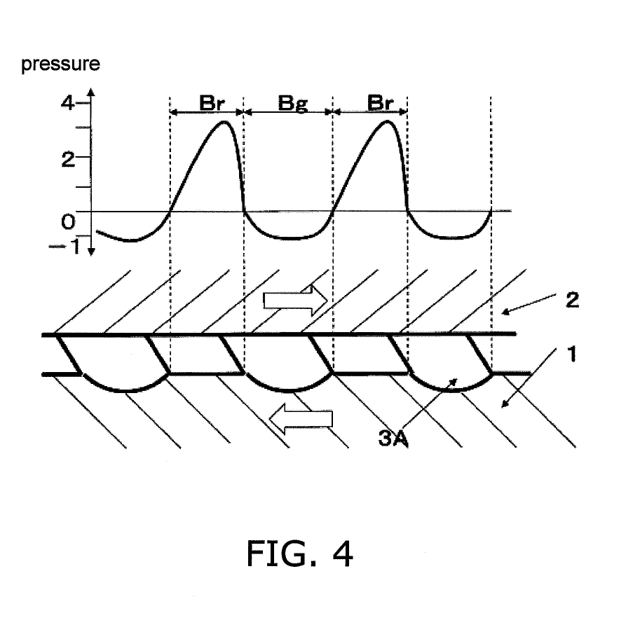

Also, as shown in FIG. 4, the hydrodynamic face has a groove portion (Bg) and a ridge portion (Br: the flat portion where there is no groove). Here, if we assume a relative speed with respect to the opposing flat face on the surface of the shaft 2, since the gap changes in the portion of the hydrodynamic groove 3A, a fluid dynamic constriction effect generates higher pressure as shown in the graph of FIG. 4 at the ridge portion (Br), which lifts the shaft 2 and allows it to rotate in a non-contact state.

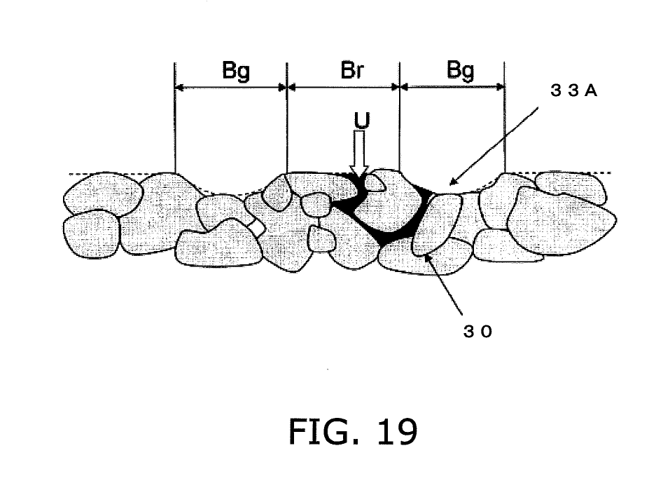

Here, since the volumetric density of the sleeve is sufficiently high in this embodiment, there are no through-holes that communicate between the ridge and groove portions of the hydrodynamic face as shown in FIG. 19. Thus, there is no worry that pressure generated by the ridge portion will leak out to the groove portion, as shown in FIG. 3.

The pores present on the above-mentioned hydrodynamic face will now be described.

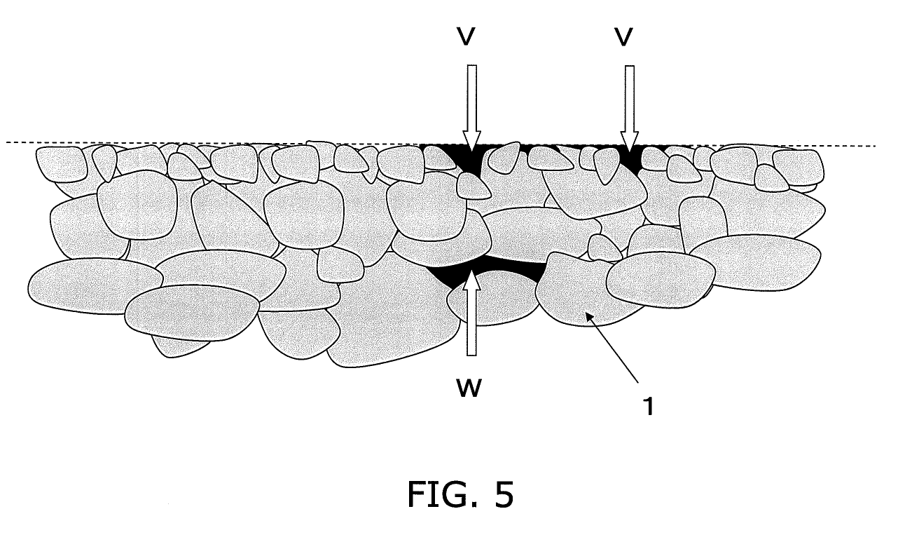

FIGS. 3 and 5 are cross sections of the hydrodynamic face of the sleeve 1 composed of a sintered material.

FIG. 5 is a cross section of the sleeve when the volumetric density of the sintered material is approximately 93%.

With a hydrodynamic bearing device such as this, the pressure generated during rotation remains sufficiently high, without leaking, so the shaft 2 rotates completely in non-contact fashion.

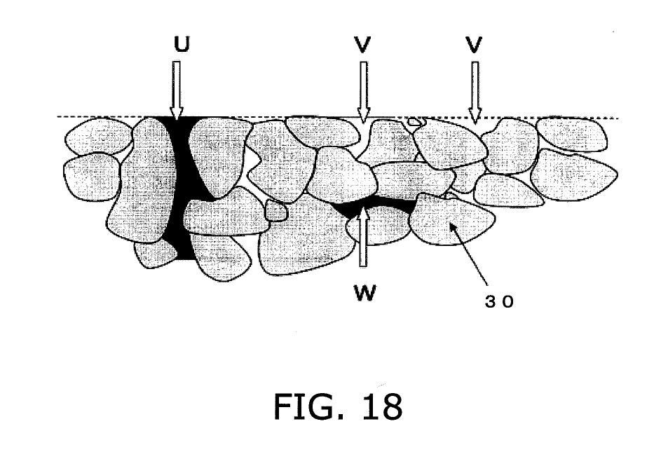

Also, since there is a reduction in the through-pores U as shown in the conventional example in FIG. 19, the generated pressure does not leak, nor does the lubricant 11 leak outside of the sleeve 1. The amount of the through-pores U in FIGS. 18 and 19 is quantitatively expressed by the through-porosity (volumetric percent).

Also, in FIG. 5, the letter V indicates substantially round or streak-like depressions remaining on the surface, which are called surface pores. These surface pores V may adversely affect the generation of pressure in the hydrodynamic groove 3A. However, the surface pores V are non-through pores that do not go all the way through, and do not lead to the interior of the sleeve 1. Thus, they do not cause the lubricant 11 to leak out. In this embodiment, the amount of the surface pores V is quantitatively expressed by the surface porosity (surface area %).

The letter W in FIG. 5 indicates pores that are closed off in the interior of the sleeve 1, and these are called internal pores. These internal pores W do not lead to the surface, so there is no danger that they will lower the pressure generated by the hydrodynamic groove 3A, and will not cause the lubricant to leak out. The amount of these internal pores is expressed as “volume %,” but since they have no effect whatsoever on the performance of the hydrodynamic bearing device, there is no need to measure or manage the internal porosity.

Next, the relationship between porosity and volumetric density of the hydrodynamic bearing device in this embodiment will be discussed.

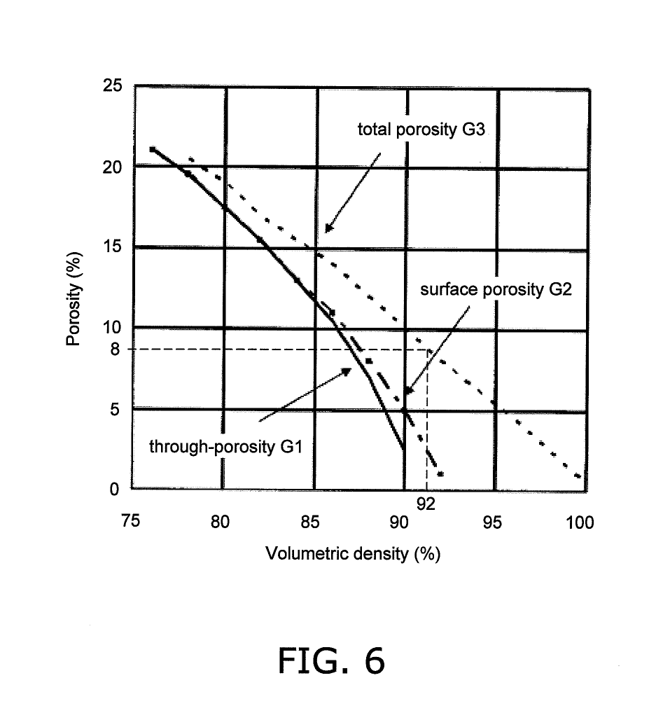

FIG. 6 shows the relationship between the various kinds of porosity (volumetric %) and the volumetric density (%) of a sleeve composed of an iron-based material. The pores here are divided into three types: through-pores, surface pores, and internal pores. Surface pores and internal pores are also called non-through pores, and [so pores] are broadly classified into through-pores and non-through-pores. Through-pores, surface pores, and internal pores will be used in the following description.

The curve G1 shows the measured values for through-porosity (volumetric %). The curve G2 shows the measured values for surface porosity expressed as surface area % (surface porosity is evaluated by both surface area % and volumetric %). The curve G3 shows the overall porosity (volumetric %).

The overall porosity here refers to a value (volumetric %) obtained by dividing the total volume of pores classified into the three types (through-pores, internal pores, and surface pores) by the volume of the sleeve 1. This can be unambiguously calculated with the following formula from the volumetric density of the sleeve 1.

Specifically, if we let the volumetric density be 100%, then the total porosity is 0%.

Total porosity (%)=100 (%)−volumetric density (%)

As shown in FIG. 6, it was found experimentally that if the volumetric density is at least 92%, the surface porosity will be 1.5% or less (substantially between 0% and 1.5%) due to the effect of surface flow working or drawing of the surface by pressing (not shown), and with the present invention, the leakage of pressure shown in FIG. 3 is prevented by setting the volumetric density to be at least 92%.

The relationship between radial stiffness and surface porosity of the hydrodynamic bearing device in this embodiment will now be described.

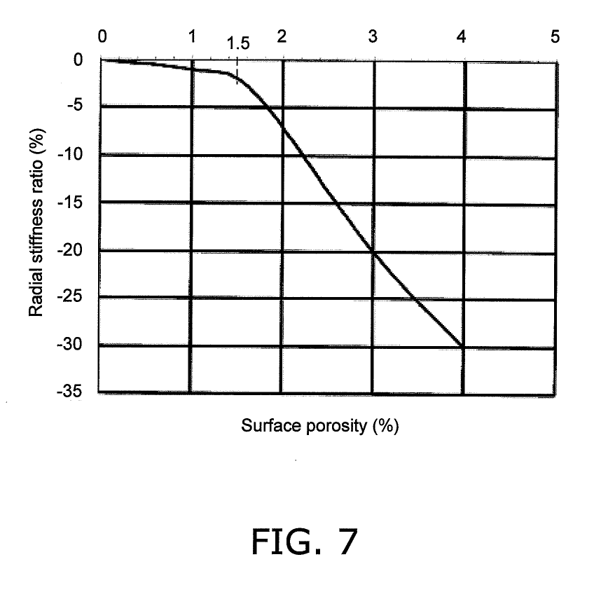

FIG. 7 shows the change in radial stiffness performance of the hydrodynamic bearing device and the surface porosity (surface area %).

With this embodiment, in FIG. 7, the through-pores, surface pores, and other such pores in the bearing surface are closed off, and the surface porosity (volumetric %) is set sufficiently low (1.5% or less), as opposed to the past, when so many pores were present that the surface pores were 2% or higher, and closer to 20%. Therefore, the proportional decrease in stiffiess is substantially close to 0%, and bearing stiffness is approximately 20% higher than with the conventional example shown in FIG. 16. Thus, there is less axial runout of the hydrodynamic bearing device, and rotational accuracy can be improved. The reason for this phenomenon is believed to be that because there is no pressure leakage from the hydrodynamic surface of the sleeve 1, a sufficiently high pressure is obtained in the bearing gap, and there is no decrease in stiffness.

In FIG. 7, a critical point is seen near where the surface porosity is 1.5%. However, the reason for this seems to be that when the surface porosity is 1.5% or less, the decrease in pressure is too small to have any effect on performance. From a fluid dynamics perspective, the depth of the surface pores is sufficiently shallower than the hydrodynamic groove shown in FIG. 4, and the surface pores (called depressions) that are far smaller than the groove width (Bg) of the hydrodynamic groove do not cause a drop in pressure. This will be described below.

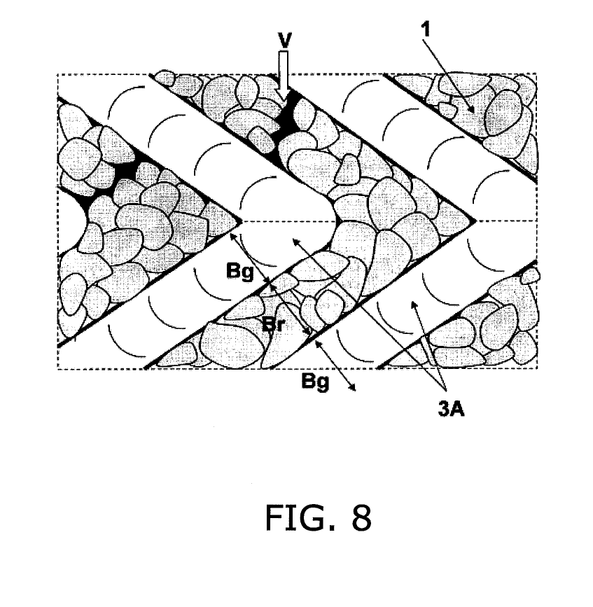

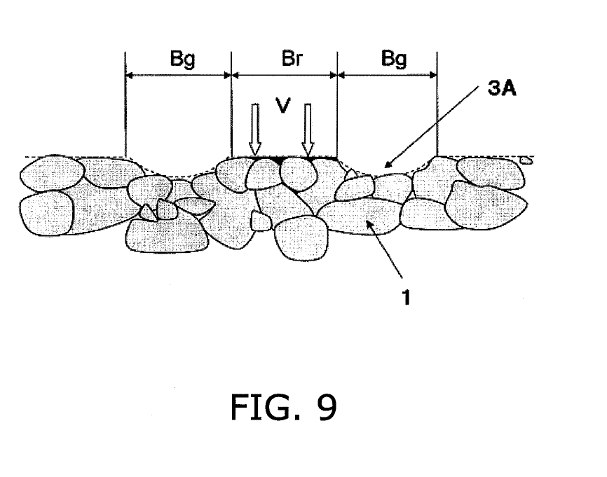

FIG. 8 is a detail view of the bearing sliding face of the sleeve 1, and FIG. 9 is a partial cross section thereof.

FIGS. 8 and 9 show a case in which the volumetric density is at least 92% and less than 100%.

Here, there are substantially no surface pores on the sliding face, but there are depressions (recesses) between surface particles caused by gaps between particles of the sintered material as indicated by the letter V in the drawings, or there are shallow streak-like depressions of 1 μm or less. If these depressions reach or exceed a certain depth, pressure generated in the hydrodynamic groove may leak out, which affects performance.

In this embodiment, the relationship between the minute numerical value of surface porosity (surface area %) and the performance of the hydrodynamic bearing device is clarified, and a hydrodynamic bearing device is configured so that there is no performance degradation due to pressure leakage, there is a design range for the hydrodynamic grooves and finished condition of the sleeve surface, that is favorable for mass production.

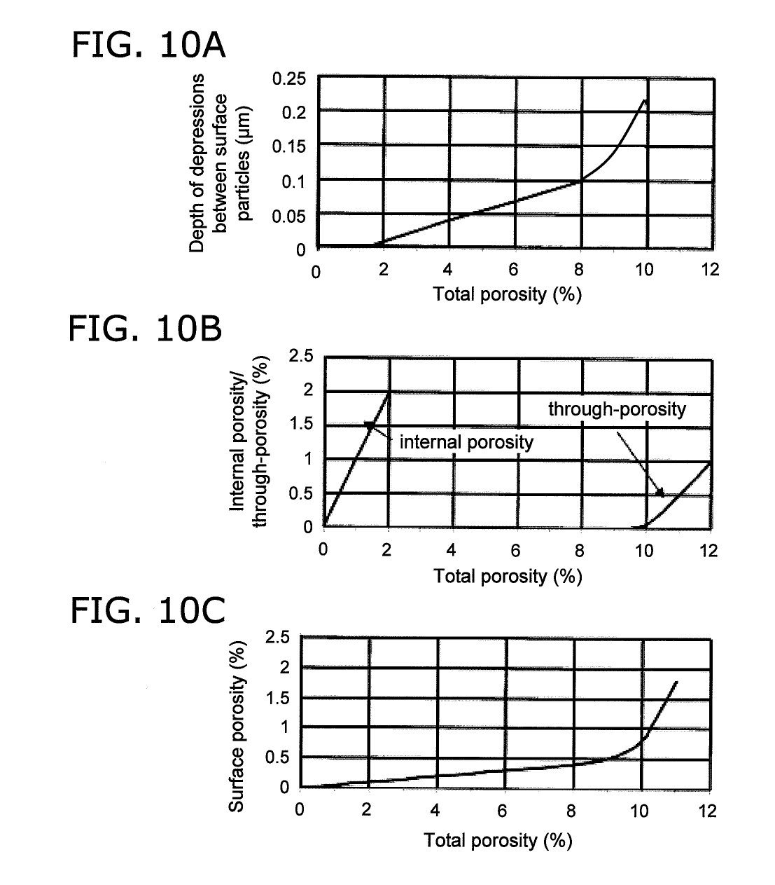

FIGS. 10A to 10C are graphs of the relationship between the total porosity (%) of the sintered material and the through-porosity (volumetric %), the internal porosity (volumetric %), the surface porosity (surface area %), and the depression depth between surface particles (μm).

Here, measurements reveal that the depression depth remaining between the surface particles of the sleeve 1 as indicated by the letter V in FIG. 8 is such that depressions or streaks begin to appear between the particles when the total porosity is at least 1.5%, as shown in FIG. 10A. About 0.0 μm of the depression depth remaining between the surface particles which is measurable by using general measuring equipments, began to appear between the particles. When the total porosity is 8%, it was found that the depth of depressions between surface particles increases to about 0.1 μm. As shown in FIG. 10B, through-pores (volumetric %) are not seen if the total porosity (volumetric %) is 10% or less, and internal pores (volumetric %) exhibit substantially the same numerical value as total porosity (volumetric %).

The measurement data in FIG. 10 is data for when the particle size is from 30 to 200 μm and the pure iron contained in the sintered material is 80%.

The method for evaluating porosity here will now be described.

Surface porosity (surface area %) is measured by calculating the proportional surface area accounted for by pores (per unit of surface area), using microscopic observation or photography with a still or video camera, etc.

Total porosity (volumetric %) is found as follows. First, the apparent volume V1, which can be computed from the outside diameter, is multiplied by the specific gravity ρ1 of the material to obtain a weight W1 when there are no pores, etc., and this is compared with the actual weight W2. This weight difference Δw1 (=W1−W2) is divided by the specific gravity ρ1 of the material to obtain a volume Δv1=(Δw1/ρ1) corresponding to the total pores. Thus, the porosity is measured by what is known as a specific gravity method, which expresses the ratio (Δv1/V1) of the total pores in the apparent volume.

Also, the sum (volumetric %) of the surface porosity (volumetric %) and the through-porosity (volumetric %) is calculated as follows. First, the difference Δw2 (=W3−W2) between the actual weight W2 of the bearing member that does not contain anything and the weight W3 after vacuum-filling with a lubricant is found. This is divided by the specific gravity ρ2 of the lubricant to obtain a volume Δv2 corresponding to the surface pores and through-pores, which expresses the ratio (Δv2/V1) to the apparent volume V1.

Also, the surface porosity (volumetric %) is calculated as follows. First, the through-pores and surface pores are filled with an uncured resin, after which just the resin in the surface pores is washed away, just the resin in the through-pores is made to impregnate the pores and is cured, and the weight W4 is measured. The difference Δw3 (=W5−W4) from the weight W5 after vacuum-filling with the lubricant is then found. This result is then divided by the specific gravity ρ2 of the lubricant to obtain a volume Δv3 corresponding to the surface pores, which expresses the ratio (Δv3/V1) to the apparent volume V1.

These measurements and calculations can be performed to find the total porosity (volumetric %), surface porosity (volumetric %), through-porosity (volumetric %), and surface porosity (surface area %). (Regarding the above-mentioned vacuum filling, see U.S. Pat. No. 3,206,191, etc.)

Next, we will describe a case in which the ridge width is varied [to find how this affects] radial stiffness and surface porosity with the hydrodynamic bearing device of this embodiment.

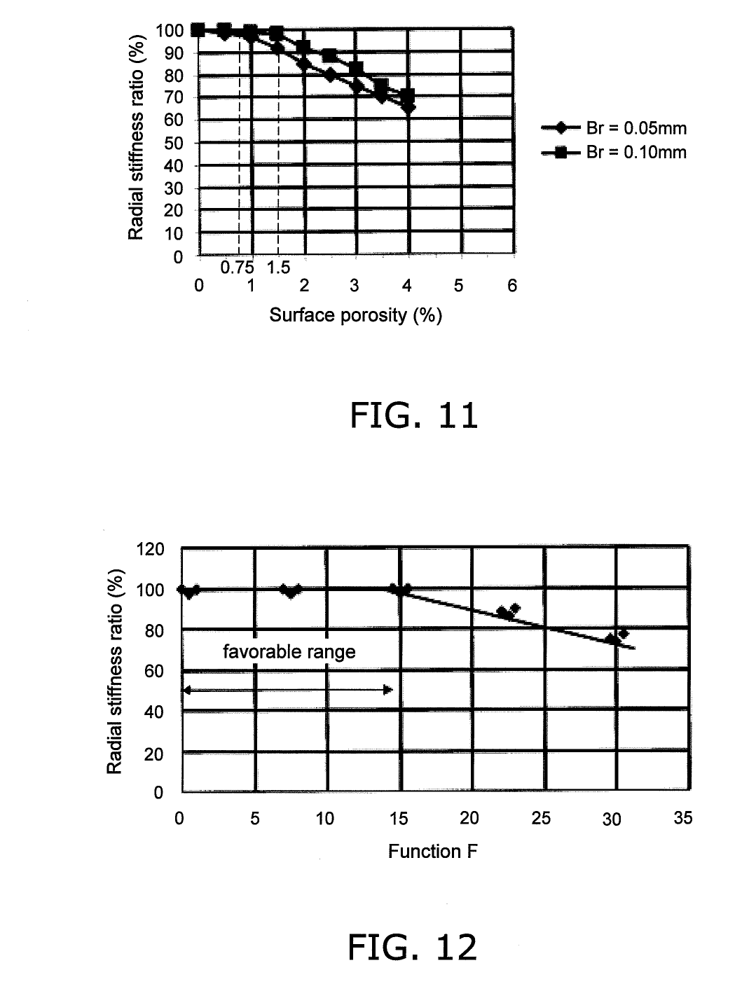

FIG. 11 is a graph of the results of finding the stiffness by measuring the eccentricity from the rotational axis center when an unbalanced load is applied to the radial bearing of two types of hydrodynamic bearing device with ridge widths of 0.1 mm and 0.05 mm, and measuring the proportional decrease in radial bearing stiffness of the hydrodynamic bearing device due to surface porosity (surface area %). The unbalanced load was applied, for example, by air push method, in which air is blown in the axial direction at one spot on a rotating disk, and the change in RRO versus that during steady state rotation is measured, and the applied load was dynamic rather than static.

The measurement results indicated that when the ridge width was 0.1 mm, no decrease in stiffness was noted until the surface porosity reached 1.5%. On the other hand, when the ridge width was only 0.05 mm, radial stiffness began to decrease when the surface porosity reached 0.75%. If the ridge width is 0.1 mm or less as above, it was confirmed that stiffness decreased by approximately 20% when the surface porosity was 3%.

These results lead to the conclusion that with a hydrodynamic bearing device comprising a sleeve made of a high-density sintered material whose volumetric density is approximately 90% or higher as shown in FIG. 6, pressure begins to drop as the depressions between surface particles become deeper, as shown in FIG. 9. This indicates that pressure leakage and decreased stiffness are less likely to occur when the ridges are sufficiently wide because there is a lower probability of communication with the hydrodynamic groove adjacent to the surface pores V, but that pressure leakage is apt to occur when the ridges are narrow because there is a higher probability of communication with the hydrodynamic groove adjacent to the surface pores V.

From a fluid dynamics perspective, it is believed that if the surface pores are deeper than the hydrodynamic grooves shown in FIG. 4, or about as wide as, or wider than, the width (Bg) of the hydrodynamic grooves, then the depressions between surface particles and surface pores will lower the pressure by hydrodynamic generation.

Based on the above assumption, in this embodiment we defined not only the surface porosity, but also a function that takes into account the ridge width, and discovered the relationship to radial stiffness.

As discussed above, FIG. 12 shows the relationship between the function F (Formula 1) that takes into account the effect of the ridge width of the hydrodynamic groove, and the proportional radial stiffness.

Function F=surface porosity/ridge width (Formula 1)

surface porosity: measured value by using an image of the bearing sliding face ridge width: shortest distance (mm) between hydrodynamic grooves

As above, surface porosity is sometimes expressed as surface area %, and is sometimes expressed as volumetric %. Here, surface porosity is expressed as surface area %, which indicates the proportion of the pore portion per unit of surface area, using an image of the bearing sliding face obtained by microscopy or photography with a still or video camera, etc. Also, the ridge width expresses the distance from a boundary line between a ridge and a groove (hydrodynamic groove) to an adjacent boundary line measured in the normal direction, and is the shortest distance between hydrodynamic grooves. Br in FIGS. 3, 4, and 8 correspond to this.

It can be seen from the graph in FIG. 12 that if the numerical value of the function F is 15 or less, a hydrodynamic bearing device is obtained with which there is no pressure leakage and the decrease in stiffness is sufficiently small. Furthermore, cases were described in which the ridge width was 0.05 mm and 0.1 mm, but similarly, when the ridge width is between 0.05 and 0.1 mm, a hydrodynamic bearing device with no pressure leakage and sufficiently little decrease in stiffness can be obtained as long as the numerical value of the function F is 15 or less. Also, it is inferred that the surface porosity and the ridge width have the same relation when the ridge width was 0.05 mm or less.

With the configuration shown in FIG. 1, the cover 31 that was shown in the conventional example in FIG. 16 is not necessary, so the sleeve 1 can be attached more accurately to the base 10.

For example, the right angle of the thrust plate 7 to the bearing hole 1A in the drawing can be easily and stably maintained at 2 μm or less. Thus, even when hydrodynamic bearing devices are mass-produced, performance variance can be reduced, which is highly beneficial for industrial purposes. Furthermore, the surface of the sintered bearing is suitably roughened, and no bonding grooves or the like have to be provided for bonding, so consistent strength can be obtained at a lower cost.

An example in which the shaft 2 rotated was described above, but a similar effect can be obtained with what is known as a fixed-shaft type of bearing configuration, in which the sleeve 1 and the rotor hub 5 are integrally fixed and rotate together, and the shaft 2 is integrally fixed to the base 10.

As discussed above through reference to FIGS. 10 and 11, a hydrodynamic bearing device with high performance and high reliability can be obtained by setting the ridge width of the hydrodynamic grooves to be at least 0.10 mm and setting the surface porosity to be no more than 1.5% on the bearing inner peripheral surface of the sleeve 1 composed of a sintered metal.

### Other Embodiments

### (A)

In the above embodiment, as discussed through reference to FIGS. 6, 7, 10, and 11, a hydrodynamic bearing device with little decrease in radial stiffness was obtained by setting the surface porosity and ridge width to be within specific ranges, but the present invention is not limited to this.

For example, a similar effect will be obtained when the density of the sleeve 1 composed of a sintered metal is managed from the standpoint of volumetric density.

More specifically, a hydrodynamic bearing device with high performance and high reliability can be obtained by setting the volumetric density to be at least 92% and the ridge width of the hydrodynamic grooves to be at least 0.10 mm. This is because if the volumetric density is at least 92%, the total porosity (volumetric %) will be 8% or less, and the surface porosity (surface area %) will be either zero or 1.5% or less.

(B)

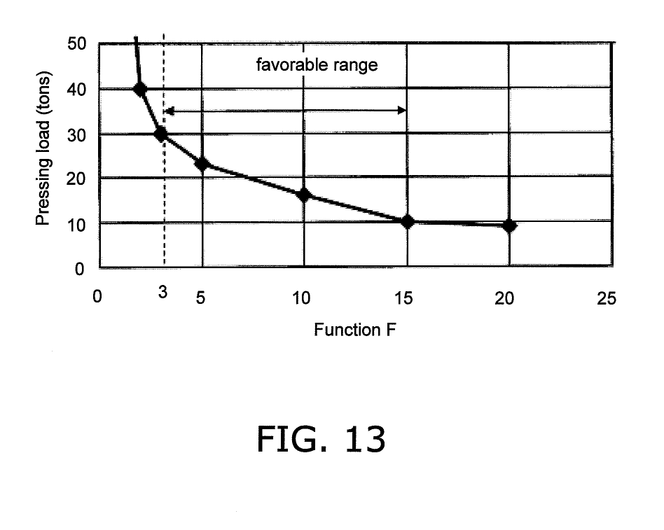

FIG. 13 is the result of experimentally determining the relationship between the function F expressed by Formula 1 and the pressing pressure when the sleeve 1 in the embodiment of the present invention shown in FIG. 2 is pressed with an ordinary hydraulic press (not shown).

When the function F was at least 15, surface porosity was not be reduced that much, so sufficient working could be performed even when the pressing force exerted by the press was about 10 tons. However, to work the sleeve 1 such that the function F will be about 3, the pressing pressure has to be at least three times higher. The result is that there is the risk of stress breakage of the metal mold (not shown) within a short time.

In particular, to reduce the value of the function F to less than 3, it was confirmed that the required pressing pressure rises sharply as shown in FIG. 13, which is not suited to mass production. This phenomenon is caused by the following reason that when the function F is large, the molecules of the iron-based metal that is the raw material of the sleeve 1 are freely compressed and molded within the mold (not shown), but to work the sleeve 1 so that the function F becomes smaller, the pressure of the press also becomes higher. In particular, when the function F is less than 3, the working becomes similar to forging, with the iron-based metal molecules packed nearly 100% within the mold, so no further compression is possible. Thus, it is thought that a markedly higher pressing pressure is needed to mold iron-based microparticles.

Because of the above, when cost is taken into account, we can see that good productivity can be maintained by setting the value of the function F to at least 3 as shown in FIG. 13. Therefore, when radial stiffness and cost are taken into account, the value of the function F is preferably at least 3 and no more than 15.

(C)

In the past, a sleeve was produced on a lathe from a rod of free-cutting steel or a copper alloy, and the surface was plated with nickel to improve rustproofing and abrasion resistance. However, as in the above embodiment, when a sleeve composed of a sintered material is nickel plated, there is the risk that the corrosive plating solution will remain inside the sintered material, and that this solution will subsequently have an adverse effect on the sintered material.

With the configuration of the above embodiment shown in FIGS. 1 and 2, iron accounts for at least 80% of the material of the sleeve 1, and the surface of this sintered material is subjected to steam treatment at high temperature, which forms a film of at least 2 μm and consisting mainly of tri-iron tetroxide (Fe₃O₄; iron oxide black) or di-iron trioxide (Fe₂O₃; iron oxide red).

This ensures good abrasion resistance and slip at the sliding faces between the sleeve 1 and the shaft 2 composed of high-manganese chromium steel or stainless steel, and affords a hydrodynamic bearing device with a longer service life.

The steam treatment involves controlling the amount of oxygen while bringing the surface into contact with steam at a temperature of about 500 to 600° C., and the surface pores can be filled in by covering the surface of the sintered material in which pores are present with an iron oxide film. To achieve this pore filling by steam treatment, it is important for any bubbles that are to be filled in to be small and few enough, which is accomplished by increasing the volumetric density.

Thus, a satisfactory effect can be obtained as long as the porosity and volumetric density are as in the present invention. Also, the iron content must be at least a certain amount to conduct the oxidation reaction required for pore filling, and the iron content is preferably at least 80%.

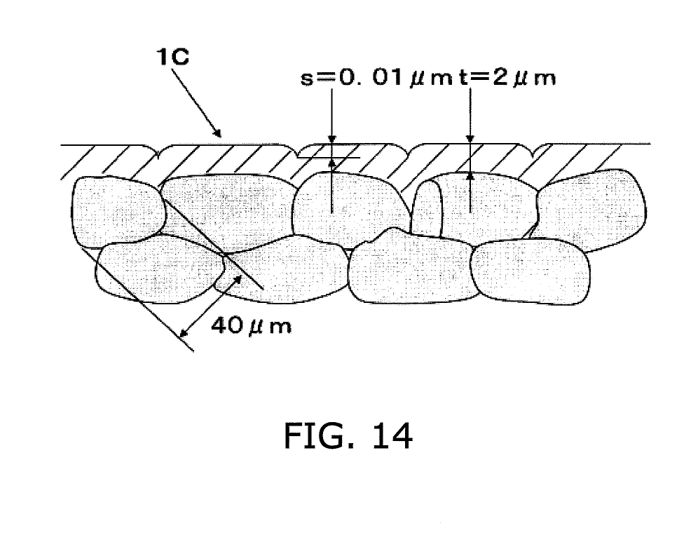

Also, as shown in the cross section of FIG. 14, depressions and streaks can be smoothly embedded with the iron oxide film if the thickness of the iron oxide film is set to be at least 2 μm. Furthermore, the depth of these can be reduced to zero, or, as shown in FIG. 14, the depth s can be made extremely shallow, or about 0.01 μm. As a result, the surface porosity (surface area %) is lowered to very close to 0%, which means that the pore filling treatment will substantially prevent the lubricant from passing through.

The above measures eliminate leakage of hydrodynamic pressure generated on the sleeve surface, and allows the reliability of the hydrodynamic bearing device to be increased. Also, if the lubricant 11 is prevented from oozing from the surface of the sleeve 1 into the interior, then there is no need to impregnate the sleeve 1 with the lubricant 11 ahead of time as in the conventional examples, and since there is no leakage of the lubricant 11 to the outside, the cover 31 is also unnecessary.

(D)

With the configuration shown in FIG. 1, the shaft 2 is made of either high-manganese chromium steel or stainless steel, and the sleeve 1 is made of a sintered metal composed of at least 90 vol % iron-based microparticles, the result being that the coefficient of linear expansion of the shaft is 16.0 to 17.3 E⁻⁶ (/° C.), and the coefficient of linear expansion of the sleeve is 11.0 E⁻⁶ (/° C.).

Therefore, compared to when the sleeve is made of a copper alloy, the radial gap is wider between the sleeve 1 and the bearing hole 22A at low temperatures, there is a reduction in loss torque, and rotation is lighter. As a result, even though the viscosity of the oil used as the lubricant 11 increases at low temperatures, the rotational friction torque of the hydrodynamic bearing device is not that high, making it possible to keep the current consumed by the motor low.

Also, since a sintered metal composed of iron-based particles containing at least 50% iron-based microparticles of ferrite-based stainless steel or martensite-based stainless steel is used as a sleeve, the coefficient of linear expansion of the shaft can be from 16.0 to 17.3 E⁻⁶ (/° C.), and the coefficient of linear expansion of the sleeve can be 10.3 E⁻⁶ (/° C.). Thus, the radial gap is wider between the shaft 2 and the bearing hole 22A at low temperatures and rotation is lighter. As a result, even though the viscosity of the oil used as the lubricant 11 increases at low temperatures, the rotational friction torque of the hydrodynamic bearing device is not that high, making it possible to keep the current consumed by the motor low.

More specifically, SUS 416, SUS 420, or SUS 440 martensite-based stainless steel, or SUS 410L, SUS 430, or another such ferrite-based stainless steel can be selected as the material of the iron-based particles.

E)

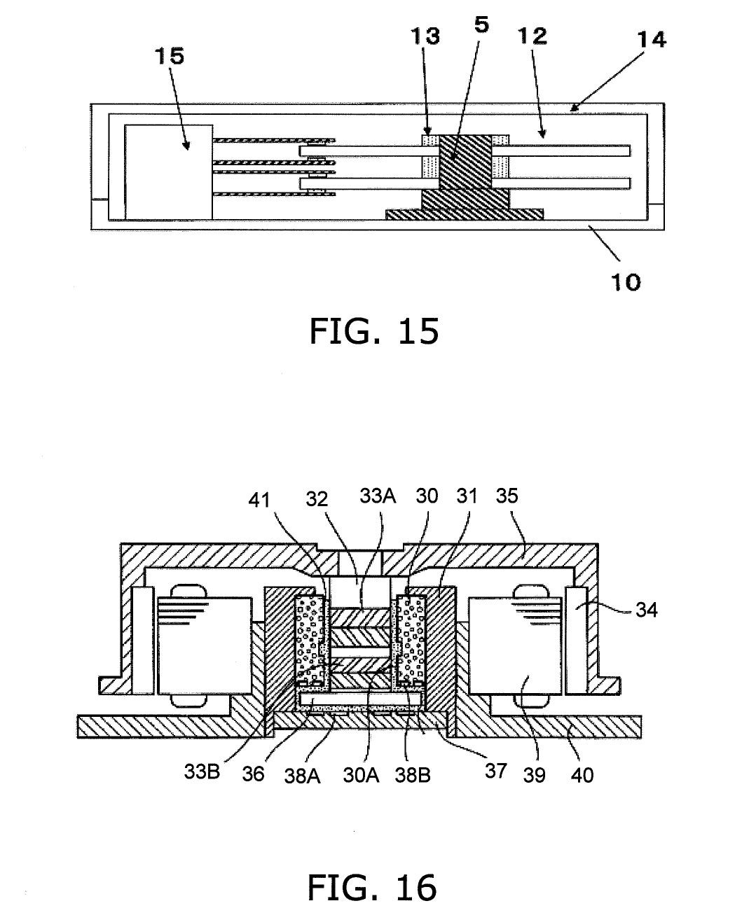

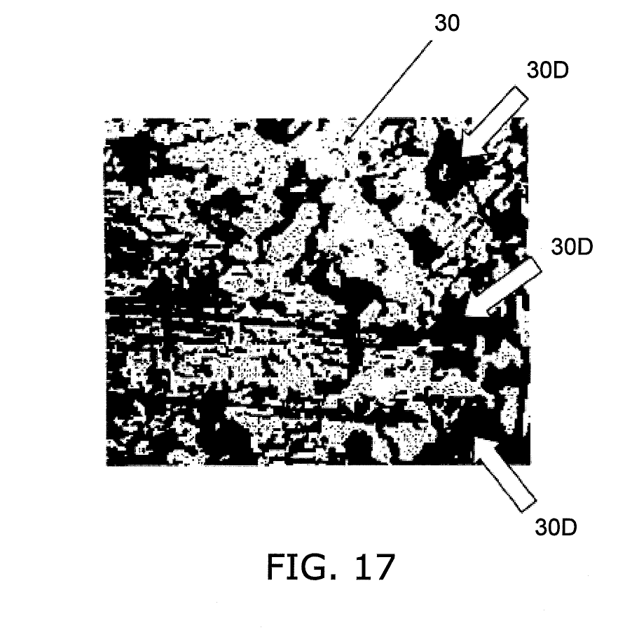

FIG. 15 depicts an information recording and reproduction processing apparatus in which the hydrodynamic bearing device of the present invention has been installed.

Typical examples include a hard disk device, optical disk device, and magneto-optical disk device. As shown in FIG. 15, another example is a personal computer in which no disk is installed, but a fan for cooling the CPU is installed.

This information recording and reproduction processing apparatus comprises a disk 12, a clamper 13, an upper lid 14, and ahead actuator unit 15.

With the constitution of the present invention, as described in the above embodiments, the lubricant will not leak out of the hydrodynamic bearing device and foul the disk, nor will any gas that has evaporated from leaked lubricant foul the inside the device. Thus, an information recording and reproduction processing apparatus with excellent performance and reliability can be obtained.

As discussed above, with the hydrodynamic bearing device of the present invention, the porosity of the surface of the sleeve is set to be within a specific range, and the ridge width of the hydrodynamic grooves is maintained at a specific value or higher, the result being that there is no leakage of pressure, and the radial bearing stiffness does not decrease. Also, since the oil used as the lubricant 11 does not ooze onto the surface, the sintered sleeve can be attached directly to the base or hub, without using a cover, and this improves attachment accuracy.

Furthermore, the hydrodynamic bearing device of the present invention was described by using a radial bearing formed on the sleeve 1 as an example, but the same effect can be obtained with a thrust bearing formed on the sleeve 1.

More specifically, for example, with the thrust bearing formed by the hydrodynamic groove 8B and the sleeve opposite this groove shown in FIG. 1, a thrust hydrodynamic groove is formed on the sleeve side. Further, the present invention can also be applied to a conical bearing that combines the characteristics of a radial bearing and a thrust bearing.

With the present invention, pores on the surface of a sleeve composed of a sintered metal are kept to a specific, tiny amount or less, which makes it less likely that pressure generated in a hydrodynamic groove will leak from the surface of the sintered material. Thus, it is possible to prevent the bearing from rubbing and seizing, etc., without decreasing the stiffness of the bearing. Also, the volumetric density of the sintered material can be kept to a specific value or higher, allowing the porosity of the sintered sleeve surface to be reduced stably. Further, an iron oxide film can be formed in at least a specific thickness on the surface in order to further reduce porosity. Also, since the coefficients of linear expansion of the shaft and sleeve are kept substantially the same by using at least 80% iron for the material of the sintered sleeve, the problem of rotation becoming heavier at low temperatures can be solved.

### INDUSTRIAL APPLICABILITY

The present invention makes it possible to obtain a hydrodynamic bearing device with which a decrease in radial bearing stiffness is prevented by eliminating the leakage of hydrodynamic pressure, there is no need to provide a cover as in the past, and which affords good performance and reliability of the hydrodynamic bearing device at low temperatures, and is well suited to mass production, as well as an information processing apparatus equipped with this bearing. Because of this, the present invention can be applied to a wide range of devices in which hydrodynamic bearing devices are installed.

1. A hydrodynamic bearing device, comprising:
a shaft;
a sleeve that is formed from a sintered material and has a bearing hole in which the shaft is inserted in a state of being capable of relative rotation; and
a hydrodynamic groove formed in the inner peripheral surface of the bearing hole in the sleeve,
the sleeve has a surface porosity of 1.5% or less, and the ridge width of the hydrodynamic groove is at least 0.10 mm.

2. A hydrodynamic bearing device, comprising:
a shaft;
a sleeve that is formed from a sintered material and has a bearing hole in which the shaft is inserted in a state of being capable of relative rotation; and
a hydrodynamic groove formed in the inner peripheral surface of the bearing hole in the sleeve,
the sleeve has a volumetric density of at least 92%, and the ridge width of the hydrodynamic groove is at least 0.10 mm.

3. A hydrodynamic bearing device, comprising:
a shaft;
a sleeve that is formed from a sintered material and has a bearing hole in which the shaft is inserted in a state of being capable of relative rotation; and
a hydrodynamic groove formed in the inner peripheral surface of the bearing hole in the sleeve,
the sleeve is such that the value of the following function F is 15 or less:
Function F=surface porosity (surface area %)/ridge width (mm)
where surface porosity is the ratio (surface area %) of the pore surface area, as measured from a photograph of the sliding face of a hydrodynamic bearing device, and ridge width is the shortest distance (mm) between hydrodynamic grooves.

4. The hydrodynamic bearing device according to claim 3, wherein the value of the function F is at least 3 and no more than 15.

5. The hydrodynamic bearing device according to claim 1,
wherein iron accounts for at least 80% of the sleeve portions, and an oxide film whose main portion is tri-iron tetroxide (Fe₃O₄) or di-iron trioxide (Fe₂O₃) is formed in a thickness of at least 2 μm on the surface.

6. The hydrodynamic bearing device according to claim 2,
wherein iron accounts for at least 80% of the sleeve portions, and an oxide film whose main portion is tri-iron tetroxide (Fe₃O₄) or di-iron trioxide (Fe₂O₃) is formed in a thickness of at least 2 μm on the surface.

7. The hydrodynamic bearing device according to claim 3,
wherein iron accounts for at least 80% of the sleeve portions, and an oxide film whose main portion is tri-iron tetroxide (Fe₃O₄) or di-iron trioxide (Fe₂O₃) is formed in a thickness of at least 2 μm on the surface.

8. A spindle motor, comprising:
the hydrodynamic bearing device according to claim 1; and
a base constituting the bottom portion,
wherein the sleeve is fixed directly to the base.

9. A spindle motor, comprising:
the hydrodynamic bearing device according to claim 2; and
a base constituting the bottom portion,
wherein the sleeve is fixed directly to the base.

10. A spindle motor, comprising:
the hydrodynamic bearing device according to claim 3; and
a base constituting the bottom portion,
wherein the sleeve is fixed directly to the base.

11. An information processing apparatus comprising the spindle motor according to claim 8.

12. An information processing apparatus comprising the spindle motor according to claim 9.

13. An information processing apparatus comprising the spindle motor according to claim 10.
